(19) United States
(12) Patent Application Publication
(10) Pub. No.: US 2012/0010904 A1
(43) Pub. Date: Jan. 12, 2012

(54) METHOD FOR REVERSE PHYSICIAN - PATIENT MATCHING FOR IN-PERSON HEALTH CARE SERVICES AND TELE-CONSULTATIONS

(76) Inventors: David Buck, Boston, MA (US); Justin Ko, Boston, MA (US); Rod Underhill, Julian, CA (US)

(21) Appl. No.: 13/179,360

(22) Filed: Jul. 8, 2011

Related U.S. Application Data
(60) Provisional application No. 61/363,102, filed on Jul. 9, 2010.

(51) Int. Cl. G06Q 50/00

(52) U.S. Cl. 705/3

(57) ABSTRACT

A method of matching patients and health care providers includes registering a patient user and associating the patient user with a unique identifier. Information about the patient user is obtained and the patient user information is associated with the unique identifier. A health care provider can be registered and information about the health care provider can be obtained.

### CROSS-REFERENCE TO RELATED APPLICATION

This application claims the benefit of U.S. Provisional Application No. 61/363,102, filed on Jul. 9, 2010, and is incorporated herein by reference in its entirety.

### FIELD

This disclosure relates to methods and systems for matching patients and health care providers.

### BACKGROUND

The matching of patients and health care providers is an important part of the process of receiving and providing health care. However, current systems for matching patients and health care providers suffer from many deficiencies. This has resulted in inefficiency as resources in the health care system often go unused and has also resulted in decreased quality of care as patients are not optimally matched to providers in regards to diagnosis, expertise and location. In addition, current systems do not adequately take advantage of the richness of medical diversity that exists beyond local providers, which can further reduce the quality of treatment available to patients. Accordingly, there is a need for improved systems and methods of matching patients with health care providers.

### SUMMARY

In one embodiment, a method of matching patients and health care providers is provided. The method can comprise registering a patient user and associating the patient user with a unique identifier; obtaining information about the patient user and associating the patient user information with the unique identifier; and registering a health care provider and obtaining information about the health care provider. The patient user information can comprise identifying information and medical information.

In some embodiments, the medical information comprises a health issue for which the registered patient user is seeking medical assistance. A means can be provided for the registered patient user to select one or more of the following services: tele-consultations, elective procedures, health maintenance, specialists visit, expert consultations, clinical trials and new treatments, home visits, and package deals. The patient user information can further comprise a scheduling request that indicates one or more preferred times for setting up an appointment. The method can include a step of determining a match between a registered patient user and a registered health care provider based on the patient user information and the health care provider information, and that determination can be provided to one or both of the matched registered patient user and the matched registered health care provider.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a system a method of matching patients and health care providers based on patient and provider characteristics and/or preferences.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and subcombinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached FIGURE may not show the various ways in which the disclosed methods can be used in conjunction with other methods. Additionally, the description sometimes uses terms like “determine” and “generate” to describe the disclosed methods. These terms are high-level abstractions of the actual operations that are performed. The actual operations that correspond to these teams may vary depending on the particular implementation and are readily discernible by one of ordinary skill in the art.

The disclosed technology can be used, for example, to allow patients and health care providers to be “optimally” matched. As used herein, such superlative terms as “optimal” do not mean to make perfect or achieve the highest level of effectiveness or functionality. Rather, the terms “optimal” and the like refer to improving choices based on known criteria to permit a client or health care provider to make an informed decision. Thus, an optimized match may not be the “best” match; however, it may be the patient's desired match based on various other considerations.

There are many reasons that matching patients and health care providers can be difficult. For example, provider management software is varied making integration difficult. This is as opposed to the airline industry where there are several large providers. This has resulted in low physician adoption in online scheduling tools. Accordingly, it is desirable to provide a system for matching patients and health care providers that does not require communication with existing provider management software. Alternatively, the system can be configured to communicate and/or be integrated with current health care provider management systems.

Also, patients often do not have the enough knowledge about health care providers. For example, patients often do not always know who the best provider for their problem is. This is true even if providers are readily accessible. Actively advertising can be a sensitive area for providers, and if not done properly it may damage a provider's image. Also, patients do not always know what the most appropriate service for their problem is. For example, a patient may wonder: “I have a question about managing my diabetes. Can I get this answered online? Should I see my primary care physician? Or should I see a specialist?” This is even more problematic for patients with less common diseases, since they often do not have readily-available access to providers who specialize in their particular diagnosis, or even know where such providers exist. Similarly, physicians do not currently have a way to locate or identify patients that they are best suited to treat. This results in dispersion of their energy and less effective care. Accordingly, it is desirable to provide a system for matching patients and health care providers that can exchange information about those who need services as well as those who provide services in the health care industry.

Health insurance can also create barriers for matching patients and health care providers. Many aspects of the healthcare industry lack transparency with regards to costs, quality and accessibility. This makes learning about available services and providers extremely difficult. Privacy of personal health information makes open discussion of problems and providers difficult. Limits of who a patient can see based on insurance complicates a patient's search process. Also, physicians do not have a guarantee that a patient will pay their co-pay, or service price whether individually or through insurance. Moreover, physicians do not have a guarantee that a patient will show up for their appointment making scheduling difficult. Accordingly, it is desirable to provide a system for matching patients and health care providers that can manage the privacy, pricing, and scheduling difficulties that currently exist in the health care industry.

Current patient-physician interaction occurs mostly locally. Accordingly, it is desirable to provide a system for facilitating patient physician communication nationally or globally to take advantage of new communications technologies and travel availability.

The systems and methods described herein provide a way to optimally match a patient with a provider and facilitate appropriate communication between patient and provider, and, in some embodiments, between various providers. The systems and methods described herein comprise a database of patients, their problems (e.g., symptoms, illnesses, and/or concerns), and their healthcare needs. The systems and methods described herein also can provide a way for providers to access the database in a useful and efficient way and to identify patients who are best suited to their practice of medicine. In some embodiments, the system can be a stand-alone system that does not require integration with existing provider scheduling software.

In some embodiments, patients can provide information to the system. This information can include, for example, describing characteristics such as their diagnosis, insurance, location and medical problem that they want answered (along with various other characteristics, such as those identified below). If desired, to maintain the privacy of the patients, this information can then be separated from any personal identifying information and used to create a database of a patient population and their particular medical needs.

A method for providers to access this database can be provided such that the providers can access at least a portion of the information in the database in an efficient manner that maintains the privacy of individual patients. After finding a suitable patient the provider then may respond to the patient in a proposal offering his/her services. This can included automated responses and notifications after new patients and problems are entered into the database. Patients can subsequently be given a compilation of provider responses and given the option of selecting said providers for their service.

The system and methods disclosed herein can also include incentives to entice the patient to pay providers and show up for appointments/consultations if one has been scheduled. This can include a registration/scheduling fee which, once a patient shows up for a consultation, will be put towards paying their insurance co-pay and/or the price of the service if paying individually.

The system and methods disclosed herein can track the results of the patient and provider experience, in relationship to patient and provider characteristics. This allows further determination of which patient problems and specifications are ideally suited to which providers. Thus, the system can providing a method to optimally match patients and providers which may extend beyond either ones knowledge of what is best for them.

The system and methods disclosed herein can also include a method for extending the reach of patient care by optimally matching providers and patients beyond local boundaries. This can be facilitated by taking advantage of new technologies allowing for tele-consultations and more accessible travel. These patients may be offered services and providers whom they did not know were available, yet may be of benefit to their care. This can include providers specializing in a particular diagnosis and new research and treatments regarding the diagnosis. By both utilizing unused health care resources and optimally matching provider to patient the system creates a new level efficiency in the medical system.

### Patient User Requests for Proposals and Interaction with Database

An illustrated embodiment of a method for matching patients and health care provides disclosed herein is described below.

User fills out request for proposal form. This may take place online, through a mobile device, or through a paper form to later be entered into the database. In a first step, the entered information can include:

a. Identifying information. This information can be kept separate of the database to maintain patient user confidentiality, and can be linked in a secure way.

b. Health Problem/Question

c. Pertinent medical information, including medical information relevant to appointment/procedure

d. Patient user chooses service/procedure requested. Options can include, for example, tele-consultations, elective procedures, health maintenance, specialists visits, expert consultations, clinical trials and new treatments, home visits, and package deals.

Tele-consultations can include tele-consultations over the telephone or video. It can also include personalized health education in which not treatment or diagnosis is provided, or pre-visit consultations. Health maintenance can comprise low level care, including, for example, refilling of medication, vaccines, fly shots, and eye exams. Specialist visits can include, for example Allergist, Dermatologist, Psychiatrist, Plastic Surgeon etc.

Expert consultations can include second opinions and other various consultations. This can include consultations on less common diseases and/or difficult problems. This can include tele-consultations over the telephone or video, including consultations from specialists on rare or difficult problems. For example, a patient might want to know the answer to the question “My child has muscular dystrophy and needs an operation, is she at risk?”

In clinical trials and new treatments, a user (patient) can select whether they are interested in clinical trials or new treatments currently in use or development for a particular diagnosis. Home visits can be selected to request or identify physicians who are willing to come to a patient's house for a consultation. Package deals can include various items that are included together, such as an entire course of treatment that includes re-visits, free visits for a certain period of time, etc. This option can be similar to concierge medicine and, at least in some embodiments, users could bid for a period of time.

e. Custom generated fields can be provided to further explain problem, set agenda for visit, etc. This may be tailored to patients chosen service request. For example, a patient could provide information that provides the following information: “Problems I would like to address during my visit” ______, ______.” Or “My current symptoms include ______.”

f. Location of the patient can be provided by entering the information, or it can be automatically detected by an IP address or GPS (e.g., if using a mobile device). The user can also enter a set radius from their location of where they would like to see a provider. A default radius can be automatically provided. In certain instances, such as when seeking a specialist or other expert in a particular area of interest, the location feature can be disabled or expanded to cover a larger area.

g. Specific times/dates. Users can select a desired time window for an appointment or pre-procedure consultation. If desired, users can also select one or more back up time windows for the appointment or procedure in case the first is not available.

h. Payment. Users can select whether they would like to pay by cash or insurance. For example, a user can select “insurance” from drop down box or enter free text.

In a next step, the user can select a predetermined set of providers to send request to if desired. They may select these providers based off of our directory of physician profiles. Alternatively by default the user request can be available to all qualifying providers through the database.

In some embodiments, the user can also be requested to pay small fee, before getting referrals or selecting provider. This payment can be given to the physician to cover co-pay once patient shows up at their appointment. If patient user does not find a suitable provider, this payment can be refunded.

In some embodiments, a database of all patient users and entered information specific to each patient user can be created. Each patient user can be assigned a unique identifier that does not include their name or other identifying information in order to keep information in the database confidential. This identifier can be linked with information entered previously, such as the information described above. Entries in the database can expire after a set period of time so that the database is current. For example, a patient's entry in the database can expire after 3 months (or some other longer or shorter time period), if not renewed. Not only does this help to maintain the information in the database current, it can help to protect patient confidentiality since an entry can be deleted or removed after a set time period.

Response System and Interaction with Database

Providers can register with the system and created a provider profile. The provider profile can include, for example, the provider's credentials and contact information for verification. In some embodiments, the provider may be required to pay a subscription fee for access to database (described above). A provider profile can include general information, such as some of the information described above with respect to the patients. In addition, the provider can include additional optional information that the provider would like potential patients to see. Provider's can elect to make their profile public or hidden.

A registered provider can be given access to search the database of patients. A registered provider can search patient user database for specific criteria defined by the provider, including, for example, diagnosis, cash paying patients, specific insurance, type of service, procedure, tele-consultation, etc. If desired, the search can be done automatically by a predetermined set of criteria listed by the provider

The database can then be matched with provider specifications and a list of patient users that fulfills the specifications can be generated. The generated list of patients can be made available to each individual provider through several possible methods. In one embodiment, physician practices/hospitals can pay subscription fee to be included in these “matched” notifications. In other embodiments, subscribing physicians/hospitals can receive daily email/notification of potential patients matching their specifications. Alternatively subscribers log on to website to see list of potentially interested patients.

In a preferred embodiment, the registered providers are not given other information that the patient entered that is not relevant to the parameter they are searching for. For example, a doctor looking for a cash only patient in area code 02116 might be given patient A, but will not be told about his diabetes. Similarly, a diabetes doctor looking for a patient might be given the same patient A, but will not be told about his willingness to pay cash. In addition, the information provided to subscribers (registered providers) can be limited to the selected information and can be devoid of personal health identifiers and/or contact info.

Subscribers can select patients they are interested in having as customers. Providers can select patients on procedures/types of appointments and times available in their schedule. Providers can also select patients based on other certain criteria (e.g., those who will pay by cash or those who have insurance). Providers can also select to use an escrow service provided by the website.

Subscribers can then provide bid, pitch, and/or other information to the prospective patients. Prices can be provided based on a user's insurance. A free text area can be provided whereby providers can describe why their service is better than others. Special offers can also be presented by the physicians, including, for example, discounts on co-pays, free transportation, free hotel if not nearby, etc.

Subscribers can also use pre-populated response to facilitate the ease of use of the system. For example, providers can pre-enter information such as what insurance they take, cash prices for procedures, times they have available etc. If a physician chooses to respond to a request, the relevant information can be pre-populated in the response. Automated responses can also be used. For example, a provider can specify a set of criteria, which when present in a patient user, an automatic response will be generated. Automated responses can include limiting criteria, as well as selecting criteria. Potential criteria may include but are not limited to location, specific type of insurance, specific procedure, specialty requested, and diagnosis. For example a provider may select to generate an automated proposal to patients (1) with a particular type of insurance, (2) with rheumatoid arthritis, and (3) who are looking for an office consultation.

Compilation and Selection of Provider Proposals

The system described herein can process “bids” and output a compilation sheet showing bidding providers to a user (prospective patient). The information provided to the user can comprise provider profile information including, for example, hospital affiliations, accredited specialties, specific areas of expertise, a picture/video profile of subscriber if available, patient care team, location, and free text provided by provider.

Hospital/Provider quality information and subscriber ratings/reviews based on other users can be provided.

The user can select an offer (bid, etc) from among compilation sheet, and the selected subscriber can notified that the user has selected them. If a slot is still available, the patient can be automatically scheduled for appointment/procedure/tele-consultation. The physician subscriber and patient users can also be given contact information by which they can schedule and appointment. Pre-visit preparation can continue if provider and patient wish (e.g., pre-visit forms can be requested to be completed by the user). After the subscriber meets with the physician, the subscriber can be given the opportunity to rate his or her physician encounter.

Physician to Physician Communication

In many cases the patient is not the most able or the most suitable person for soliciting consultations for themselves, or for interpreting the results of the consultation. In these circumstances, a requesting physician already involved in the patient's care (for example, a primary care physician) can initiate the consultation. This has the added advantage of keeping the patients care integrated with their current care team.

The systems and methods described here can incorporate this physician to physician communication in a similar method to that previously described for patient to physician communication. A physician can enter a patient into the database along with the patient's problem, diagnoses and background medical info. The physician can be able to select what type of service he is requesting for the care of the patient.

For example, the physician can seek general advice regarding a problem unknown to his expertise (e.g., “curbsiding”). The consulting physician can provides general advice without knowing detailed information about the patient. The physician can also seek a general or specific consultation, including for example, requesting another physician to read and interpret imaging and diagnostic tests, or reviewing other information about the patient. The physician can seek to tele-consult over phone, email, video conferencing. This can include outsourcing of consults to other countries. The requesting physician can enter selected information about the patient characteristics, their problem and their medical history in a manner similar to prior description for patient-patient use. This information can include, for example, location and insurance. The requesting physician can also enter a price for the consultation.

A database can be created that includes patients and their needs and information as outlined before, as well as the referring physician and his information. Consulting physicians can search this database in a similar manner as the previous database: by problem, insurance, location, type of visit (e.g., tele-consult, in person) and additionally by characteristics of the referring physicians. The consulting physicians can return a proposal for consultation, including a price, if not covered by insurance. The requesting physician can choose among proposals.

### Protected Search

In one embodiment, a search of the database can be limited by what patient information a provider conducting a search is given. This can help maintain patient confidentiality by ensuring that a searching provider will not be able to obtain multiple patient identifiers. This can also help prevents abuse of the system by providers by preventing cherry picking only the healthiest, easiest to care for patients.

For example, a doctor looking for a cash only patient in area code 02116 might be given patient A, but will not be told about his diabetes. A diabetes doctor looking for a patient might be given the same patient A, but will not be told about his willingness to pay cash.

Provider Accounts—Directory of Physician Profiles

A directory of physician profiles can serve as a resource for patients looking to set up an appointment or other service with a specific physician. Patient users can select individual physicians who they would like to send a request for proposal. In addition, the profiles can provide contact information and ability to make appointments directly with the physician in instances where the patient does not want to use the reverse matching process. The physician profile can also be part of the information contained in the previously mentioned compilation sheets.

A unique aspect of the physician directory is the use of videos to provide an introduction of the provider to the patient. In addition, the provider can record videos of answers to common medical questions they are asked. Hereby giving the user an idea of their medical/communication skills and how they practice medicine. These videos answers will be linked to the providers profile and will be available to all users creating a video library of medical questions. Patient users may search these questions as a way to both educate themselves and find compatible physicians for their medical care.

A patient can enter similar information regarding their requested medical service as previously described. Instead of or in addition to submitting the request to all subscribing physicians, they may choose individual physicians to send the request to. The patient user can clicks on “submit request” or “add to current request” button on physicians profile. A patient user can choose to submit requests for proposal to a list of their “favorite providers.” A patient may also choose to submit a request for proposal to other providers recommended by their “favorite providers.”

In some embodiments, a video directory of provider introductions and video answers to medical questions can be provided.

“Favorite Providers” and use of physician profiles for physician and educational updates can be provided. For example, a patient user may add an individual physician to their “favorite providers.” These may include providers whom they have a working in person relationship with, prior visit, or a provider who is an expert in their field. When these providers submit a new video answer to a medical question, or text update the patient user can be notified. The patient user can follow the notification link to see the video, or text update to learn about new information regarding the provider or his area of expertise.

Feedback/endorsements from patients who have interacted with provider can be left on a physicians profile page.

Endorsements from other providers can be permitted. For example, other providers registered with the site who are familiar with the provider can leave an endorsement of the provider on their profile page. In addition, if a physician is not taking appointments they can provide a list of other physicians in the same area of practice they would recommend. These recommendations can be made available to patients who had been interested in scheduling with the original physician.

Physician Matching and Recommendation Services

A consequence of the previously described database and user tracking is the ability to provide matches based off of previously successful interactions. This allows us to further determine which patient problems and specifications are ideally suited to which providers in a way that has never been done before.

This system of determining probability of a successful outcome based on user and provider characteristics could be extended to include both patient and providers who have not registered with the website.

Matching Based on Probability of a Successful Outcome

Patient-provider characteristics with a successful outcome can be tracked to improve the optimization of the system. For example, the system can track which patient users, identified by a unique identifier, successfully completed the previously described process with a particular provider.

The system can also track which patient users, identified by a unique identifier, did not successfully complete the previously described process with a particular provider. Or had a bad experience resulting in negative feedback.

The system can match patient characteristics (such as diagnosis, location etc) to characteristics of the provider (age, location, gender, specialty) and mathematically determines the correlation (both positive and negative) between specific provider-patient characteristics and positive outcome.

Recommendation of providers and patients based on calculated correlations. The system can use the previously determined correlations to recommend physicians to patients who mathematically have the highest chance of a successful outcome. The system can use the previously determined correlations to recommend patients to physicians who mathematically have the highest chance of a successful outcome

Provider-provider recommendations can also be used to improve the probability of a successful outcome. Thus, a provider can list similar providers that they would recommend to their patients. If a particular provider is booked the patient will be directed to other physicians that that particular physician recommends. The patient can search his network of “favorite physicians” and their recommended providers when looking for a consultation.

Automated Physician Response System

Provider may pre-enter information such as what insurance they take, cash prices for procedures, times they have available etc. If a physician chooses to respond to a request, the relevant information can be pre-populated in the response. For example Physician X takes your insurance. Or physician Y's cash price for your procedure is $xxx. If a provider takes X insurance which the user has stated he has in his request, this is matched up with a list of co-pays and prices specific to that insurance. (A database of the co-pay prices may be easily put together from information provided by insurance companies.) These co-pay prices can be provided with the proposals submitted to the patient user. Alternatively, if not available, this information may be manually entered by a provider. The provider's response can then automatically include this information. For example Dr. Y takes your insurance and the co-pay is $20. If you have a deductible, the out of pocket expense will be $xxx.

A provider may specify a set of criteria, which when present in a patient user, will generate an automatic response. These may include limiting criteria, as well as selecting criteria. Potential criteria may include but are not limited to location, specific type of insurance, specific procedure, specialty requested, and diagnosis. For example a provider may select to generate an automated proposal to patients with X insurance, with rheumatoid arthritis who are looking for an office consultation.

Registration Fee—Co-pay System

Providers have no guarantee that a patient intends to show up for an appointment or a procedure thus making patient scheduling difficult. Similarly providers have no guarantee that a patient is able or willing to pay for the service. The system described herein can incorporate a registration fee/co-pay system that provides incentives to the patient user to only schedule appointments they intend on keeping and paying for.

A patient user may be asked to pay a small fee when registering for the website, or before scheduling an appointment. This registration fee will be held by the website. A user schedules a service via the previously described methods. If the patient follows through with the service, the registration fee will be given to the provider as a payment towards the patients co-pay or service fee. If the patient does not show up for the service, they will not be refunded the registration fee.

User Accounts

User accounts can include a past history of providers contacted, and their personal ratings of these providers. Users can add notes about each visit (e.g., questions they have, or had answered). Recommendations from physician etc. can be added. If desired, the system can collect information, health result from physician for user account. User accounts can include suggested physicians for user similar to previous providers contacted. Requesting physician accounts may be linked to an account number identifying hospital/institution.

Health Care Provider Recommendation Method for Patients

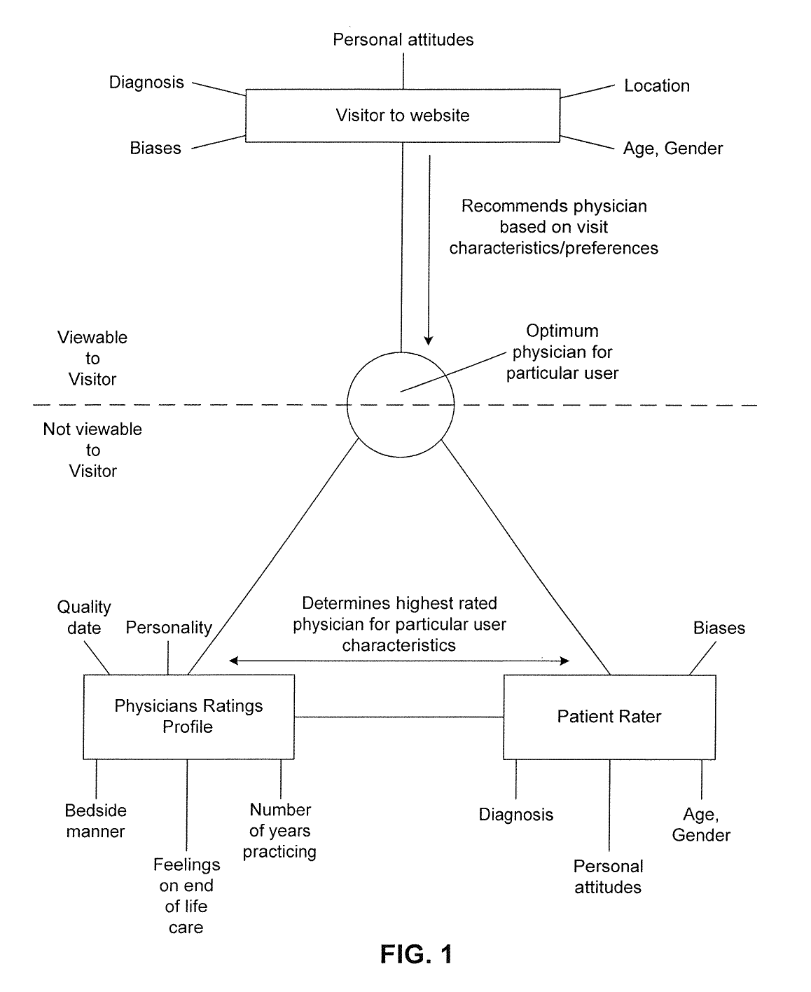

FIG. 1 schematically illustrates an embodiment where a health care provider recommendation method for patients can be provided. It remains extremely difficult for patients to find health care providers who are a good match for them in terms of personality, quality and professionalism. Finding a good health care provider has mostly relied on word of mouth, for example getting recommendations from friends or family. This method has limitations in scope as people are limited to their circle of contacts, as well as use fullness as the best provider for one person may not be the best provider for another.

The method and systems described herein can extend physician recommendations in a way that uses the input from many individuals to optimally match patient and providers. It does this by determining what matches between patient and provider characteristics have previously resulted in a successful outcome. The system can then use this information to make provider recommendations that have the highest chance of being successful.

Initial Collection of Information Regarding Patient User.

A patient user visits a website in order to find a health care provider, or to leave a review about a health care provider. The patient user can enter characteristics about themselves (or an individual they are attempting to find a provider for). These may include the following, for example: age, sex, location, medical problem, diagnoses, location, personal preferences, feelings towards gender issues, end of life issues, importance of talking/spending time with a health care provider, feelings about autonomy/paternalism in a health care provider, and importance of cost

Patient User Rating.

The patient fills out a form reviewing a health care provider they have seen. This may include, for example: the providers identifying characteristics, name, location, field of medicine, overall rating of provider on a point scale (for example 3 out of 5 stars), point scale ratings of specific areas, time spent with physician, bedside manner, quality of care, cost, free text comments about physician.

Correlation of Patient-Physician Characteristics with Positive Rating.

A database can be created from the previous information consisting of patient rater characteristics and provider characteristics. For each patient characteristic, the correlation with a positive and negative review for each provider can be determined. Similarly for each patient characteristic, the correlation with a positive or negative review for each provider characteristic is determined.

Provider Recommendations.

A patient user looking for a provider fills out a form on the website. This form contains the same characteristics listed above. The system can use the correlations of patient characteristics to provider characteristics previously calculated to determine which provider the patient has the highest probability of having a successful experience with. The system can return a list of the top providers determined by the correlations. The list may also include a compiled list of ratings and comments for the specific physicians recommended.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method of matching patients and health care providers, the method comprising:
registering a patient user and associating the patient user with a unique identifier;
obtaining information about the patient user and associating the patient user information with the unique identifier; and
registering a health care provider and obtaining information about the health care provider;
wherein the patient user information comprises identifying information and medical information.

2. The method of claim 1, wherein the medical information comprises a health issue for which the registered patient user is seeking medical assistance.

3. The method of claim 1, further comprising a means for the registered patient user to select one or more of the following services: tele-consultations, elective procedures, health maintenance, specialists visit, expert consultations, clinical trials and new treatments, home visits, and package deals.

4. The method of claim 1, wherein the patient user information further comprises a scheduling request that indicates one or more preferred times for setting up an appointment.

5. The method of claim 1, further comprising:
determining a match between a registered patient user and a registered health care provider based on the patient user information and the health care provider information; and
providing the match information to one or both of the matched registered patient user and the matched registered health care provider.

6. The method of claim 5, further comprising:
wherein at least a portion of the registered patient user information is restricted from the registered health care provider when the match information is provided to the registered health care provider.

7. The method of claim 1, further comprising:
receiving a request from the registered health care provider for assistance from another registered health care provider, wherein the request comprises a request for one or more of general advice, a consultation, an interpretation of a diagnostic test, and a tele-consultation.

8. The method of claim 1, wherein a registered patient user can provide feedback about his or her experience with a registered health care provider.

9. The method of claim 1, wherein a registered health care provider can provide a video profile or other video messages that are viewable by the registered patient users.
